(19) United States
(12) Patent Application Publication
(10) Pub. No.: US 2007/0296694 A1
(43) Pub. Date: Dec. 27, 2007

(54) Input device with display buttons and portable electronic device having the same

(75) Inventors: Nam-woo Kim, Hanam-si (KR); Seong-woon Kim, Yongin-si (KR); Sun-gi Hong, Yongin-si (KR); Byung-in Yoo, Seoul (KR); Kwon-ju Yi, Yongin-si (KR); Yill-myung Yim, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/819,133

(22) Filed: Jun. 25, 2007

(30) Foreign Application Priority Data
Jun. 26, 2006 (KR) 10-2006-0057634
Oct. 2, 2006 (KR) 10-2006-0097441

(51) Int. Cl. G09G 5/00

(52) U.S. Cl. 345/156

(57) ABSTRACT

Provided are an input device with display buttons and a portable electronic device having the same. The input device with display buttons may include a button frame having at least one button window; a touch interface, which is disposed below the button frame and generates a signal by sensing a user's touch on each of the button windows; a display panel, which is disposed below the touch interface and provides an image corresponding to each of the button windows; and an operation feeling generator generating mechanical vibration in response to the signal input from the touch interface. The portable electronic device may include the input device with display buttons.

### CROSS-REFERENCE TO RELATED APPLICATIONS

This application claims the priority benefit of Korean Patent Applications No. 10-2006-0057634, filed on Jun. 26, 2006, and No. 10-2006-0097441, filed on Oct. 2, 2006, in the Korean Intellectual Property Office, the disclosures of which are incorporated herein in its entirety by reference.

### BACKGROUND

1. Field

Embodiments relate to an input device with display buttons and a portable electronic device having the input device, and more particularly, to an input device with display buttons, which can simultaneously provide a slim body and comfortable button touch with a display function, and a portable electronic device having the input device.

2. Description of the Related Art

In general, an input device with buttons is a device generating a switch signal in response to a user's press. When a user presses a button, the input device with buttons may provide a predetermined operation feeling (sensation) to the user in order to inform the user that the pressed button has been correctly pressed. In order to provide an operation feeling (sensation) such as a button is pressed and released, most conventional input devices with buttons include an elastic member such as an elastic dome of a dome switch.

Recently, input devices with display buttons have been suggested. However, in a case of input devices with display buttons, which include a transparent display window and the elastic member for every button, the thickness of an input device with display buttons is excessively thick in a portable electronic device in which miniaturization is required. In addition, in a case where a touch screen is used to make the thickness of input devices with display buttons thin, there is no operation feeling (sensation) to indicate a successful input, and the possibility of a wrong input is increased.

### SUMMARY

According to an aspect, there is provided an input device with display buttons, which decreases the possibility of a wrong input with a button frame sectioning zones corresponding to individual buttons, makes the thickness of the input device thin with a touch interface disposed on a display panel, and provides a comfortable operation feeling of a button press to a user with an operation feeling generator, and a portable electronic device having the input device.

According to an aspect, there may be provided an input device with display buttons, the input device including: a button frame having at least one button window; a touch interface, which is disposed below the button frame and generates a signal by sensing a user's touch on each button window; a display panel, which is disposed below the touch interface and provides an image corresponding to each button window; and a sensation generator which generates mechanical vibration in response to the signal input from the touch interface.

The sensation generator may use a vibration motor as a device for generating mechanical vibration which can be transferred to the user. The sensation generator may include at least one electric responsive material member. Since the electric responsive material member can be formed in various figures, the electric responsive material member can be applied to several parts of the portable electronic device.

The touch interface may include a capacitive touch sensor, wherein the button frame may further include a window cover, which covers up each button window, and the rear surface of which contacts the touch sensor. Unlike a touch screen using a register method, since the capacitive touch sensor does not necessarily require a direct touch on the surface of the capacitive touch sensor, a transparent window cover for covering up the surface of the touch interface can be comprised.

When the sensation generator includes an electric responsive material member, the electric responsive material member may be formed integrally with the window cover. In other words, the entire or a portion of the window cover may be made of the electric responsive material. The electric responsive material member may be a member, which is disposed close to the window cover and transfers vibration due to an electrical signal to the window cover.

The touch interface may include a single transparent touch sensor in a zone corresponding to all button windows, include transparent touch sensors in respective zones corresponding to all button windows, or include at least one non-transparent touch sensor in a zone below the button frame, which is not exposed through the button windows.

According to another aspect, there may be provided a portable electronic device having an input device with display buttons, the input device may include a button frame having at least one button window; a touch interface, which is disposed below the button frame and generates a signal by sensing a user's touch on each button window; a display panel, which is disposed below the touch interface and provides an image corresponding to each button window; and an sensation generator which generates mechanical vibration in response to the signal input from the touch interface.

According to another aspect, there may be provided an input device including a button frame having at least one button window; a touch interface, which is disposed below the button frame and generates a signal by sensing a user's touch on each button window; a display panel, which is disposed below the touch interface and provides an image corresponding to each button window; a sensation generator which generates mechanical vibration in response to a control signal; and a controller which receives the signal from the touch interface and provides the control signal to the operation feeling generator.

According to another aspect, there may be provided an input device including a plurality of buttons, which display a plurality of images; a controller, which recognizes an operated button from among the plurality of buttons and generates a control signal, the control signal instructing the recognized button to experience mechanical vibration; and a sensation generator, which responds to the control signal and generates mechanical vibration for the recognized button.

According to another aspect, there is provided a portable electronic device having an input device, the input device including a button frame having at least one button window; a touch interface, which is disposed below the button frame and generates a signal by sensing a user's touch on each button window; a display panel, which is disposed below the touch interface and provides an image corresponding to each button window; and a sensation generator which generates mechanical vibration in response to the signal input from the touch interface.

According to another aspect, there is provided a portable electronic device having an input device, the input device including a button frame having at least one transparent button window; a touch interface, which is disposed below the button frame and generates a signal by sensing a user's touch on each button window; a display panel, which is disposed below the touch interface and provides an image corresponding to each button window; an operation feeling generator which generates mechanical vibration in response to a control signal; and a controller which receives the signal from the touch interface and provides the control signal to the operation feeling generator.

According to another aspect, there is provided a method of providing mechanical vibration to a user of a portable electronic device having a plurality of display buttons, the method including recognizing an operated display button from among the plurality of display buttons; and generating a control signal which instructs the recognized display button to experience mechanical vibration.

According to another aspect of the present invention, there is provided at least one computer readable medium storing computer readable instructions to implement methods of the present invention.

### BRIEF DESCRIPTION OF THE DRAWINGS

These and/or other aspects, features, and advantages will become apparent and more readily appreciated from the following description of exemplary embodiments, taken in conjunction with the accompanying drawings of which:

FIG. 1 is a schematic diagram of an input device with display buttons, which is prepared on a portion of a display panel, according to an exemplary embodiment;

FIG. 2 is a schematic diagram of an input device with display buttons, which includes a transparent multi-section touch interface, according to an exemplary embodiment;

FIG. 3 is a schematic diagram of an input device with display buttons, which includes a transparent one-body touch interface, according to an exemplary embodiment;

FIG. 4 is a schematic diagram of an input device with display buttons, which includes a non-transparent multi-section touch interface, according to an exemplary embodiment;

FIG. 5 is a schematic diagram of an input device with display buttons, which includes an operation feeling (sensation) generator using electric responsive material, according to an exemplary embodiment;

FIG. 6 is a schematic diagram of an operation feeling (sensation) generator using electric responsive material according to an exemplary embodiment;

FIG. 7 is a block diagram of an input device with display buttons according to an exemplary embodiment; and

FIG. 8 is a flowchart illustrating a controlling method according to an exemplary embodiment.

### DETAILED DESCRIPTION OF EMBODIMENTS

Reference will now be made in detail to exemplary embodiments, examples of which are illustrated in the accompanying drawings, wherein like reference numerals refer to the like elements throughout. Exemplary embodiments are described below with reference to the figures.

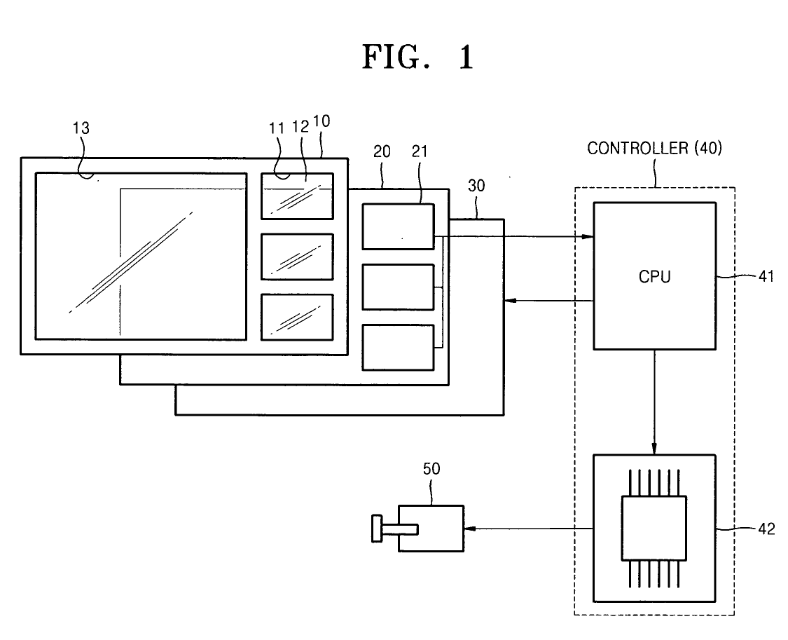

FIG. 1 is a schematic diagram of an input device with display buttons, which are prepared on a portion of a display panel, according to an exemplary embodiment. Referring to FIG. 1, a button frame 10 plays a role of a front case of a portable electronic device having a main display window 13 and includes one or more button windows 11. Each of the button windows 11 may be formed with a button type opening and include a window cover 12 covering up the opening.

A touch interface 20 is disposed below the button frame 10. The touch interface 20 includes a transparent touch sensor 21 in a zone corresponding to each of the button windows 11. The touch interface 20 may be a member in which a pattern of the touch sensors 21 is formed on a transparent substrate. A display panel 30 is disposed below the touch interface 20, and an image displayed on the display panel 30 is projected through the main display window 13, the touch sensors 21, and the button windows 11.

A portable electronic device having the input device with display buttons according to an exemplary embodiment includes a controller 40 and a vibration motor 50 as an illustration of an operation feeling (sensation) generator. Examples of portable electronic devices (mobile devices) include a cellular phone, personal digital assistant (PDA), MP3 player, digital camera, portable media player (PDP), and portable game player (PGP). The controller 40 can be made up of a central processing unit (CPU) 41 and an operation feeling (sensation) controller 42 according to their functions. The CPU 41 receives a button input signal from the touch sensor 21 of the touch interface 20 and immediately outputs a command corresponding to the button input signal to the operation feeling (sensation) controller 42. The operation feeling controller 42 generates a driving signal for directly driving the operation feeling generator (a vibration motor 50 in the current exemplary embodiment) in response to the command received from the CPU 41. However, the partition of the controller 40 is only a functional partition, and the controller 40 in real products may be formed with a single processor or chipset.

The vibration motor 50, which is an example of an operation feeling (sensation) generator, can be driven to provide an operation feeling (sensation) which may be similar to pressing of an elastic dome button to a user. For example, the vibration motor 50 can be driven to generate first vibration as soon as the user touches the window cover 12 of the button window 11 with a finger and generate second vibration as soon as the user releases the touch. Here, the second vibration may be shorter than the first vibration. However, embodiments are not limited to this. That is, various actuators for generating proper vibration can be applied to the operation feeling (sensation) generator, and these actuators can be differently driven according to their characteristics.

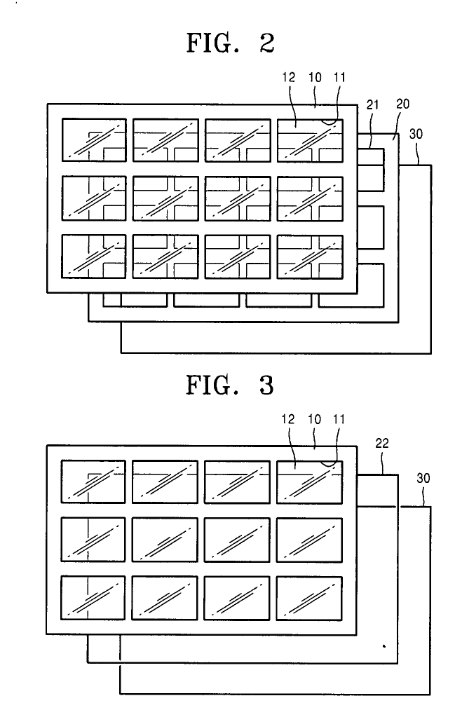

FIG. 2 is a schematic diagram of an input device with display buttons, which includes a transparent multi-section touch interface, according to an exemplary embodiment. FIG. 2 shows only a portion of the input device with display buttons, the portion including a display panel 30, a button frame 10, and a touch interface 20. Unlike the exemplary embodiment of FIG. 1, in the current exemplary embodiment, the display buttons are prepared over the entire display panel 30. The button frame 10 in which button windows 11 are disposed over the full surface can be applied to a button input unit of a portable electronic device, e.g., a front case of a lower body of a folder or sliding type mobile communication terminal. The arrangement in which the transparent multi-section touch interface 20 and the display panel 30 are disposed below the button frame 10 is the same as that of FIG. 1.

FIG. 3 is a schematic diagram of an input device with display buttons, which includes a transparent one-body touch interface, according to an exemplary embodiment. Referring to FIG. 3, unlike the exemplary embodiment of FIG. 2, a touch interface 22 can have a transparent one-body touch sensor. If the transparent one-body touch sensor is included on the full surface of the touch interface 22, a controller (40 of FIG. 1) can determine that a touch-sensed position on the touch interface 22 corresponds to a zone of which button window 11. Like the exemplary embodiment of FIG. 1 or 2, a button frame 10 can include window covers 12, each covering up each of the button windows 11 and the rear surface of which contacts the touch interface 22.

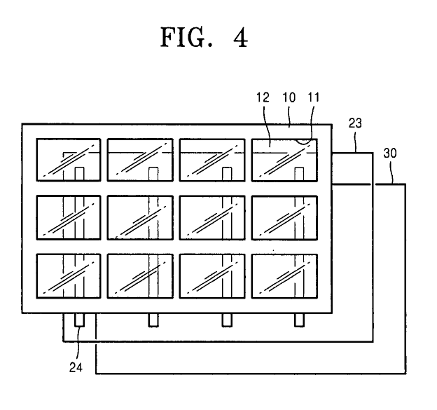

FIG. 4 is a schematic diagram of an input device with display buttons, which includes a non-transparent multi-section touch interface, according to an exemplary embodiment. In FIG. 4, a button frame 10 and a display panel 30 are the same as those in the exemplary embodiments of FIGS. 1 through 3. However, in the current exemplary embodiment, a non-transparent multi-section touch interface 23 having a plurality of non-transparent touch sensors 24 is included in the input device with display buttons. The non-transparent multi-section touch interface 23 may be a member in which a pattern of the non-transparent touch sensors 24 is formed on a transparent substrate, wherein the non-transparent touch sensors 24 are disposed in a location overlapped with an area excluding button windows 11 in the button frame 10 so that the non-transparent touch sensors 24 are hidden.

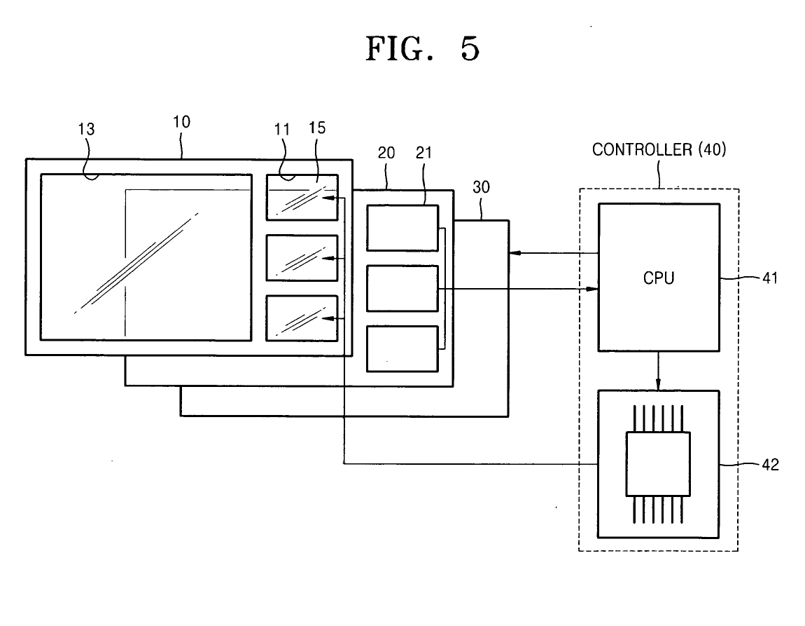

FIG. 5 is a schematic diagram of an input device with display buttons, which includes an operation feeling (sensation) generator using electric responsive material, according to an exemplary embodiment. Referring to FIG. 5, a button frame 10 plays a role of a front case of a portable electronic device having a main display window 13 and includes one or more button windows 11. Each of the button windows 11 may be formed with a button type opening and include a window cover 12 covering up the opening.

A touch interface 20 is disposed below the button frame 10. The touch interface 20 includes a transparent touch sensor 21 in a zone corresponding to each of the button windows 11. The touch interface 20 may be a member in which a pattern of the touch sensors 21 is formed on a transparent substrate. A display panel 30 is disposed below the touch interface 20, and an image displayed on the display panel 30 is projected through the main display window 13, the touch sensors 21, and the button windows 11.

A portable electronic device having the input device with display buttons according to an exemplary embodiment includes a controller 40 and window covers 15, each formed with an electric responsive material member, as an illustration of an operation feeling (sensation) generator. The entire window cover 15 can be formed with a transparent electric resistant polymer or with a cover member made of a transparent plastic substance and an electric resistant polymer coating layer formed on a portion of the cover member.

The controller 40 can be made up of a CPU 41 and an operation feeling (sensation) controller 42 according to their functions. The CPU 41 receives a button input signal from the touch sensor 21 of the touch interface 20 and immediately outputs a command corresponding to the button input signal to the operation feeling (sensation) controller 42. The operation feeling (sensation) controller 42 generates a driving signal for driving the operation feeling (sensation) generator (e.g., the window cover 15) in response to the command received from the CPU 41. However, the partition of the controller 40 is only a functional partition, and the controller 40 in real products may be formed with a single processor or chipset.

The window cover 15 made of the electric responsive material, which is an example of an operation feeling (sensation) generator, can be driven to provide an operation feeling similar to pressing of an elastic dome button to a user. For example, the window cover 15 can be driven to generate first vibration as soon as the user touches the window cover 15 of the button window 11 with a finger and generate second vibration as soon as the user releases the touch. Here, the second vibration may be shorter than the first vibration.

Though the current exemplary embodiment is configured with the window cover 15 made of the electric responsive material so that the window cover 15 directly transfers vibration to a user's fingertip, exemplary embodiments not limited to this. That is, the electric responsive material member as the operation feeling (sensation) generator can be disposed an arbitrary portion, including the inside, of a portable electric device. In this case, vibration generated by the electric responsive material member can be indirectly transferred to a user. The electric responsive material member may be formed in one-body with or disposed close to a window cover which a user's finger directly touches so that the electric responsive material member transfers vibration to the window cover.

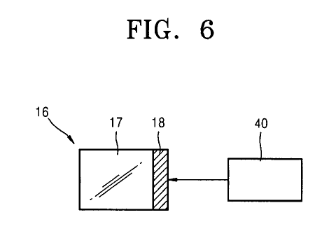

FIG. 6 is a schematic diagram of an operation feeling (sensation) generator using electric responsive material according to an exemplary embodiment. As described above, an electric responsive material member 18 can be formed in one-body with a window cover 16. In the window cover 16 in which the electric responsive material member 18 is combined with a transparent cover member 17, the transparent cover member 17 can be exposed through the button window 11, and the electric responsive material member 18 can be hidden below the button frame 10. The electric responsive material member 18 generates vibration in response to a signal received from the controller 40 so that the generated vibration can be transferred to a user's fingertip via the transparent cover member 17.

The electric responsive material applied to exemplary embodiments is not limited to specific material. That is, only if mechanical vibration is generated in response to an electric signal, ceramic material or polymer material can be used as the electric responsive material. In addition, the electric responsive material can be formed as various types of members besides exemplary embodiments described above. However, such electric responsive material member may be formed of a transparent material having small volume. Accordingly, the so-called ‘transparent speaker’ which is the electric responsive material member that is transparent and thin like paper can be applied to the electric responsive material. Moreover, Piezoceramics, such as Plumbum Zirconate Titanate (PZT), or piezopolymers, such as polyvinylidene fluoride (PVdF), are well known to those of ordinary skill in the art as examples of the electric responsive material, and besides, various materials are known, and compound material obtained by mixing the various materials can also be used as the electric responsive material.

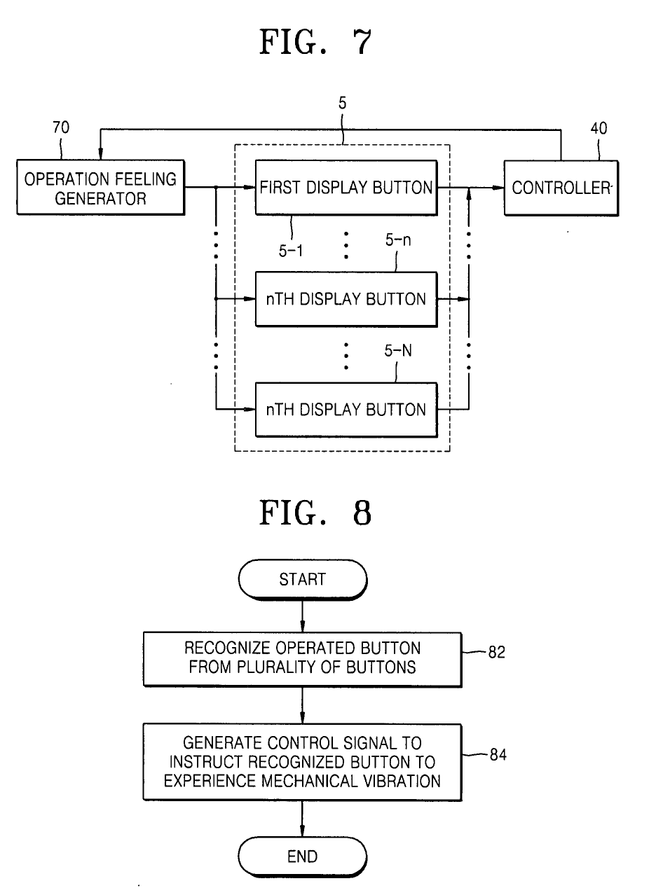

FIG. 7 is a block diagram of an input device with display buttons according to an exemplary embodiment. The input device with display buttons may include a plurality of display buttons 5, a controller 40, and an operation feeling (sensation) generator 70. In exemplary embodiments, the display button (one of 5-1, . . . , 5-n, . . . , and 5-N) are buttons having a display function. Here, n and N is a fixed number of 1≦∩≦N (where N is a fixed number of 2 or above). The window cover 12 illustrated in FIGS. 1, 2, 3, and 4, the window cover 15 of FIG. 5, and the window cover 16 of FIG. 16 can be respectively form at least a portion of the surface of the display button (one of 5-1, . . . , 5-n, . . . , and 5-N). A plurality of display buttons (5-1, . . . , 5-n, and 5-N) can be included in portable electronic devices in which the input device with display buttons according to an exemplary embodiment is applied.

Users of portable electronic devices in which the input device with display buttons according to an exemplary embodiment is applied can operate at least one display button (at least one of 5-1, . . . , 5-n, . . . , and 5-N) among the plurality of the display buttons (5-1, . . . , 5-n, and 5-N). In this case, operation of the display buttons (at least one of 5-1, . . . , 5-n, . . . , and 5-N) indicates that the users press the display buttons, and more preferably, that the users touch the display buttons.

As described above, when the users operate the display button (one of 5-1, . . . , 5-n, . . . and 5-N), the controller 40 recognizes the operated display button (one of 5-1, . . . , 5-n, . . . , and 5-N) from among the plurality of the display buttons (5-1, . . . , 5-n, . . . , and 5-N).

In this case, the controller 40 generates a control signal which instructs the recognized display button (one of 5-1, . . . , 5-n, . . . , and 5-N) to occur mechanical vibration and outputs the generated control signal to the operation feeling (sensation) generator 70.

Therefore, the operation feeling (sensation) generator 70 responds to the control signal and generates mechanical vibration in the recognized display button (one of 5-1, . . . , 5-n, . . . and 5-N). As mentioned previously, the operation feeling (sensation) generator 70 may include a vibration motor or at least one electric responsive material member.

FIG. 8 is a flowchart illustrating a controlling method according to an exemplary embodiment. The method includes recognizing an operated display button and generating a control signal which instructs the recognized display button to experience mechanical vibration (operations 82 and 84).

In operation 82, the controller 40 recognizes the operated display button (one of 5-1, . . . 5-n, . . . , and 5-N) from among the plurality of the display buttons (5-1, . . . , 5-n, . . . , and 5-N).

Then, in operation 84, the controller 40 generates the control signal which instructs the recognized display button (one of 5-1, . . . , 5-n, . . . , and 5-N) to experience mechanical vibration by outputting the generated control signal to the operation feeling (sensation) generator 70.

As described above, in an input device with display buttons and a portable electronic device having the input device, the possibility of a wrong input is decreased with a button frame sectioning zones corresponding to individual buttons, the thickness of the input device is made thin with a touch interface disposed on a display panel, and a comfortable operation feeling (sensation) of a button press is provided to a user with an operation feeling (sensation) generator. In particular, if the operation feeling (sensation) generator is embodied by using a thin and transparent electric responsive material member such as a transparent speaker, the display buttons can easily perform a display function, even if the electric responsive material is integrated with the display buttons, so that a portable electronic device using the display buttons can be manufactured in a smaller size.

In addition to the above-described exemplary embodiments, exemplary embodiments can also be implemented by executing computer readable code/instructions in/on a medium/media, e.g., a computer readable medium/media. The medium/media can correspond to any medium/media permitting the storing and/or transmission of the computer readable code/instructions. The medium/media may also include, alone or in combination with the computer readable code/instructions, data files, data structures, and the like. Examples of code/instructions include both machine code, such as produced by a compiler, and files containing higher level code that may be executed by a computing device and the like using an interpreter. In addition, code/instructions may include functional programs and code segments.

The computer readable code/instructions can be recorded/transferred in/on a medium/media in a variety of ways, with examples of the medium/media including magnetic storage media (e.g., floppy disks, hard disks, magnetic tapes, etc.), optical media (e.g., CD-ROMs, DVDs, etc.), magneto-optical media (e.g., floptical disks), hardware storage devices (e.g., read only memory media, random access memory media, flash memories, etc.) and storage/transmission media such as carrier waves transmitting signals, which may include computer readable code/instructions, data files, data structures, etc. The medium/media may also be a distributed network, so that the computer readable code/instructions are stored/transferred and executed in a distributed fashion. The computer readable code/instructions may be executed by one or more processors. The computer readable code/instructions may also be executed and/or embodied in at least one application specific integrated circuit (ASIC) or Field Programmable Gate Array (FPGA).

In addition, one or more software modules or one or more hardware modules may be configured in order to perform the operations of the above-described exemplary embodiments.

The term “module”, as used herein, denotes, but is not limited to, a software component, a hardware component, a plurality of software components, a plurality of hardware components, a combination of a software component and a hardware component, a combination of a plurality of software components and a hardware component, a combination of a software component and a plurality of hardware components, or a combination of a plurality of software components and a plurality of hardware components, which performs certain tasks. A module may advantageously be configured to reside on the addressable storage medium/media and configured to execute on one or more processors. Thus, a module may include, by way of example, components, such as software components, application specific software components, object-oriented software components, class components and task components, processes, functions, operations, execution threads, attributes, procedures, subroutines, segments of program code, drivers, firmware, microcode, circuitry, data, databases, data structures, tables, arrays, and variables. The functionality provided for in the components or modules may be combined into fewer components or modules or may be further separated into additional components or modules. Further, the components or modules can operate at least one processor (e.g. central processing unit (CPU)) provided in a device. In addition, examples of a hardware components include an application specific integrated circuit (ASIC) and Field Programmable Gate Array (FPGA). As indicated above, a module can also denote a combination of a software component(s) and a hardware component(s). These hardware components may also be one or more processors.

The computer readable code/instructions and computer readable medium/media may be those specially designed and constructed for the purposes of embodiments, or they may be of the kind well-known and available to those skilled in the art of computer hardware and/or computer software.

Although a few exemplary embodiments have been shown and described, it would be appreciated by those skilled in the art that changes may be made in these exemplary embodiments. The scope of embodiments is defined in the claims and their equivalents.

What is claimed is:

1. An input device comprising:
a button frame having at least one button window;
a touch interface, which is disposed below the button frame and generates a signal by sensing a user's touch on each button window;
a display panel, which is disposed below the touch interface and provides an image corresponding to each button window; and
a sensation generator, which generates mechanical vibration in response to the signal input from the touch interface.

2. The input device of claim 1, wherein the sensation generator comprises a vibration motor.

3. The input device of claim 1, wherein the sensation generator comprises at least one electric responsive material member.

4. The input device of claim 3, wherein the electric responsive material member comprises a transparent speaker.

5. The input device of claim 1, wherein:
the touch interface comprises a capacitive touch sensor,
the button frame further comprises a window cover, which covers up each button window, and
the rear surface of the window cover contacts the capacitive touch sensor.

6. The input device of claim 5, wherein:
the sensation generator comprises an electric responsive material member, and
the electric responsive material member is formed integrally with the window cover.

7. The input device of claim 5, wherein:
the sensation generator comprises an electric responsive material member, and
the electric responsive material member is disposed close to the window cover to transfer vibration due to an electric signal to the window cover.

8. The input device of claim 1, wherein:
the button frame has a plurality of button windows, and
the touch interface comprises a single transparent touch sensor in a zone corresponding to all button windows.

9. The input device of claim 1, wherein:
the button frame has a plurality of button windows, and
the touch interface comprises transparent touch sensors in respective zones corresponding to all button windows.

10. The input device of claim 1, wherein:
the button frame has a plurality of button windows, and
the touch interface comprises at least one non-transparent touch sensor in a zone below the button frame, which is not exposed through the button windows.

11. An input device comprising:
a button frame having at least one button window;
a touch interface, which is disposed below the button frame and generates a signal by sensing a user's touch on each button window;
a display panel, which is disposed below the touch interface and provides an image corresponding to each button window;
a sensation generator which generates mechanical vibration in response to a control signal; and
a controller which receives the signal from the touch interface and provides the control signal to the operation feeling generator.

12. The input device of claim 11, wherein the sensation generator comprises a vibration motor.

13. The input device of claim 11, wherein the sensation generator comprises at least one electric responsive material member.

14. The input device of claim 13, wherein the electric responsive material member comprises a transparent speaker.

15. The input device of claim 11, wherein:
the touch interface comprises a capacitive touch sensor,
the button frame further comprises a window cover, which covers up each of the button windows, and
the rear surface the window cover contacts the capacitive touch sensor.

16. The input device of claim 15, wherein:
the sensation generator comprises an electric responsive material member, and
the electric responsive material member is formed integrally with the window cover.

17. The input device of claim 15, wherein:
the sensation generator comprises an electric responsive material member, and
the electric responsive material member is disposed close to the window cover to transfer vibration due to an electric signal to the window cover.

18. The input device of claim 11, wherein the controller generates a first control signal when the signal according to the user's touch starts to be input from the touch interface and generates a second control signal when the signal according to the user's touch ends.

19. The input device of claim 18, wherein the controller generates the first control signal for a longer period of time than for the second control signal.

20. The input device of claim 18, wherein the controller generates the first control signal stronger than the second control signal.

21. An input device comprising:
a plurality of buttons, which display a plurality of images;
a controller, which recognizes an operated button from among the plurality of buttons and generates a control signal, the control signal instructing the recognized button to experience mechanical vibration; and
a sensation generator, which responds to the control signal and generates mechanical vibration for the recognized button.

22. The input device of claim 21, wherein the sensation generator comprises a vibration motor.

23. The input device of claim 21, wherein the sensation generator comprises at least one electric responsive material members.

24. A portable electronic device having an input device, the input device comprising:
a button frame having at least one button window;
a touch interface, which is disposed below the button frame and generates a signal by sensing a user's touch on each button window;
a display panel, which is disposed below the touch interface and provides an image corresponding to each button window; and
a sensation generator which generates mechanical vibration in response to the signal input from the touch interface.

25. A portable electronic device having an input device, the input device comprising:
a button frame having at least one transparent button window;
a touch interface, which is disposed below the button frame and generates a signal by sensing a user's touch on each button window;
a display panel, which is disposed below the touch interface and provides an image corresponding to each button window;
an operation feeling generator which generates mechanical vibration in response to a control signal; and
a controller which receives the signal from the touch interface and provides the control signal to the operation feeling generator.

26. A method of providing mechanical vibration to a user of a portable electronic device having a plurality of display buttons, the method comprising:
recognizing an operated display button from among the plurality of display buttons; and
generating a control signal which instructs the recognized display button to experience mechanical vibration.

27. At least one computer readable medium storing computer readable instructions that control at least one processor to implement the method of claim 26.
